(19) United States
(12) Patent Application Publication
(10) Pub. No.: US 2022/0079109 A1
(43) Pub. Date: Mar. 17, 2022

(54) SAFETY BANKING IN STABLES

(71) Applicant: Debbie Carroll-Beer, Poslingford Suffolk (GB)

(72) Inventor: Debbie Carroll-Beer, Poslingford Suffolk (GB)

(21) Appl. No.: 17/413,906

(22) PCT Filed: Dec. 16, 2019
(86) PCT No.: PCT/GB2019/053558

§ 371 Date: Jun. 14, 2021

(30) Foreign Application Priority Data
Dec. 14, 2018 (GB) 1820404.0

(51) Int. Cl. A01K 1/00; A01K 1/015; E04F 19/04; E04F 19/02

(52) U.S. Cl. CPC A01K 1/0005; A01K 1/0094; A01K 1/0157; E04F 19/045; E04F 2019/0431; E04F 19/026; E04F 2019/0409; E04F 2019/0413; E04F 2019/0422; E04F 19/0472

(57) ABSTRACT

A reusable banking device suitable for use in buildings such as an equine stable, the device comprising first and second faces for respectively abutting a wall and the floor of the stable, and a front face extending therebetween, the front face comprising a curved, concave portion.

### FIELD OF THE INVENTION

The present invention generally relates to reusable equine safety banking in stables.

### BACKGROUND TO THE INVENTION

In both domestic and professional stables, horses are housed in stables with concrete or stone floors that may also be covered with rubber matting, in order to provide comfort and warm for the animal. Materials, such as, straw, wood shavings, paper or wooden pellets provide not only cushioning for the horse when it lays down but will also catch and absorb any excrement and urine the horse produces whilst in the stable. The soiled bedding can then be mucked out and replaced with new material on a daily basis.

One of the greatest dangers facing a horse when within the stables, is that it could cast itself. This is where the horse rolls too close to the wall and is unable to roll away or stand up. In this situation, most horses will panic, flailing their legs in a desperate attempt to uncast themselves. In the process, the horses' legs and metal shod hooves are very capable of causing significant damage to both themselves and the surrounding stables.

In order to prevent this problem, most horse owners will pack some of the bedding materials against the walls to create an inclined or sloped bank from the floor to the wall. Should the horse attempt to roll too close to the wall, an action that could result in it becoming cast, the sloped banks will act to roll the horse back away from the stable wall. Therefore, acting to protect the horse and surrounding stalls from damage.

However, this system has many drawbacks. Firstly, as previously mentioned the bedding must be replaced on a regular basis to remove the soiled -bedding and replace it with fresh bedding. Replacing bedding can be become very costly and also prove very time consuming. Secondly, after the fresh bedding has been laid and the horse reintroduced to their stable, many animals will walk around the stable kicking the bedding around and disturbing the banks that have been created. The loss of banks reintroduces the very real danger that the horse can cast itself. The result of these limitations is a system that is expensive, time consuming to maintain and not the most effective for the stabled horses. Also, many owners place rubber matting on the walls for protection which obviously incurs extra cost.

Some attempts have been made to provide reusable alternatives to traditional bedding in the form of kerbing or banking device, including inflatable, cushion-type or concrete devices, which are relatively short and have generally convex shape or convex surfaces against which horses may rest. Such devices have a number of disadvantages, in particular the generally convex shape reducing space in the stable. Furthermore, the inflatable or cushion devices are easy to break. On the other hand, the concrete devices not comfortable for horses nor easily transportable.

The current invention seeks to overcome the above limitations.

### SUMMARY OF THE INVENTION

In a first broad independent aspect, the invention provides a reusable banking device suitable for use in buildings such as an equine stable. The device comprises first and second faces for respectively abutting a wall and the floor of the stable, and a front face extending therebetween, the front face comprising a curved, concave portion (for load bearing from a horse, in use).

The device is particularly beneficial because it prevents the need for extra bedding placed up the wall as a bank and also extra matting on the walls is no longer required which can be costly. The device also provides a uniform and ideal bank without the need for a user to construct the bank as is the case with traditional bedding.

Including a curved, concave portion which is load bearing is particularly beneficial because, in contrast to convex solutions, it maximizes the space available in the stable, whilst having the benefit of optimally avoiding the animal getting cast. A curved, concave surface extending (arching down) between the faces for abutting the walls is preferable to convex or straight surfaces, being more comfortable for the horses. The animals' legs will be protected, as well as them being prevented from being cast and so matting on the walls will not be required.

The bank comprises first and second faces for respectively abutting a wall and the floor of the stable, and a front face extending therebetween, the front face comprising a curved portion suitable for horses to roll against. This configuration is particularly beneficial because the curved, concave front face helps roll horses away from the stable wall and prevents them from casting themselves and potentially causing damage to themselves and the stables.

Optionally, the device comprises at least one cavity (for example, formed behind the curved, concave portion). This configuration is beneficial because it reduces the weight of the bank enabling it to be moved and transported with greater ease.

Preferably, the device has a height of 120 cm (although it will be appreciated that this may vary, for example in the range 110 cm-130 cm). That is, the face of the device abutting a wall of the stable (and height of the curved portion) is 120 cm. This optimum range helps with both horses and ponies flailing leg reach and protection.

Optionally, the first face comprises an attachment means for securing the banking device against the wall, wherein the attachment means includes a magnet. This configuration is beneficial because it enables the bank to be secured to the stable wall and prevents the bank from moving around during use. Using magnets is preferable to other attachment means such as hooks, which are more difficult to install and don't allow for flexible attachment/re-attachment, or to Velcro which is not as secure, and can easily get dirty or become clogged and perishes.

Optionally, the device is formed of a hard-plastics material. The particular combination if a banking device with the curved concave portion and made from hard-plastics is an effective, easy clean, lightweight and sturdy solution which has a synergistic technical advantage over known devices. Re-cyclable plastics may be sought.

Preferably, the front face further comprises a straight portion for abutting a mat placed on the floor. The straight portion may extend from the floor and forms a substantially vertical wall or ‘lip’; the straight portion is suitable for abutting a rubber floor mat located on the floor and may be for example 4 cm tall. This represents a good bolster against the matting, especially the lighter foam rubber matting where this is used, which is deeper than plain harder and heavier rubber mats.

In a further aspect, the invention provides a modular system comprising a reusable banking device as described above.

### BRIEF DESCRIPTION OF THE FIGURES

FIGS. 1a and 1b show a first, preferred, embodiment of a reusable equine banking device in perspective front and back views, respectively.

FIG. 2 shows another embodiment of a reusable equine banking device in side view, in use.

### DETAILED DESCRIPTION

With reference to the above drawings, the following detailed description provides an understanding of the present invention. A device is provided which includes banks abutted to the walls of a stable and includes a curved, concave front portion. This reduces the possibility of a stabled horse from casting whilst maximising space in the stable.

Furthermore, these are reusable banks such that they can be used repeatedly without requiring changing. This is contrary to traditional systems which utilise banks formed of a straw or shavings system which once soiled, by use, must be disposed of and replaced. The bank is firstly resistant to soiling and secondly is able to be cleaned enabling repeated reuse.

The following description will make reference to the use of shavings as a horse bedding material. It should be understood that the term shavings represents all forms of horse bedding material including; straw, wood, paper or pellets. The following description will also make reference to the device and system for use with horses; however, it should be understood that this is by way of example only and the invention is in no way limited as such. The invention is suitable for use with all members of the Equus genus, such as horses, donkeys, ponies, mules and zebras. Furthermore, the device and system are envisaged to be suitable for use with a variety of hooved animals which are prone to casting, such as cows, sheep, pigs, llamas and alpacas. In addition, the bank is described for use in a stable such as those known in the art. However, it is considered that the current invention is not limited as such and is suitable for use in any building with walls and a floor.

Aspects of the invention is envisaged to function as an individual item or as a modular system whereby multiple banks are arranged around the walls of a stable as desired. The modular system allows the banks to be utilised in stables with a range of shapes, sizes and orientations. Furthermore, the banks are envisaged to function in addition to traditional bedding materials or stable matting or both.

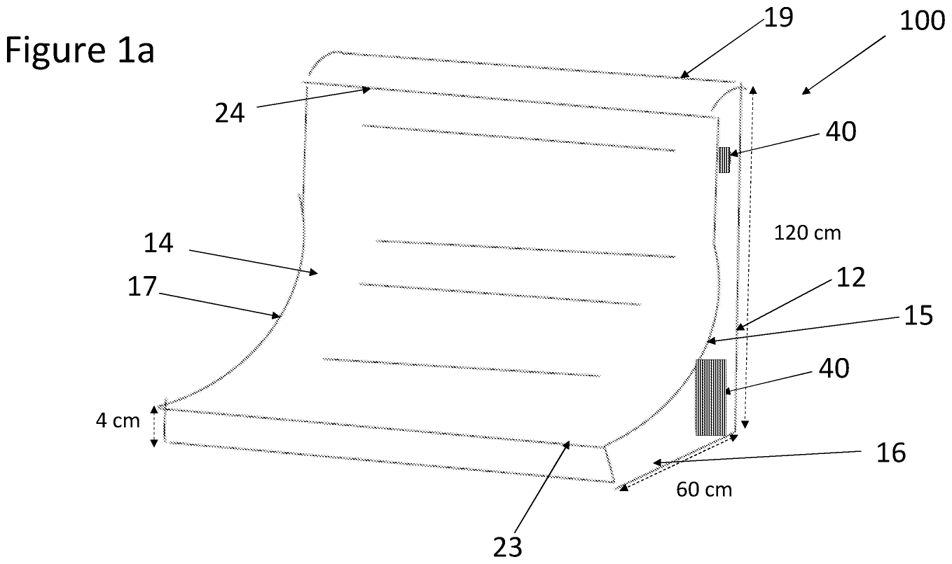

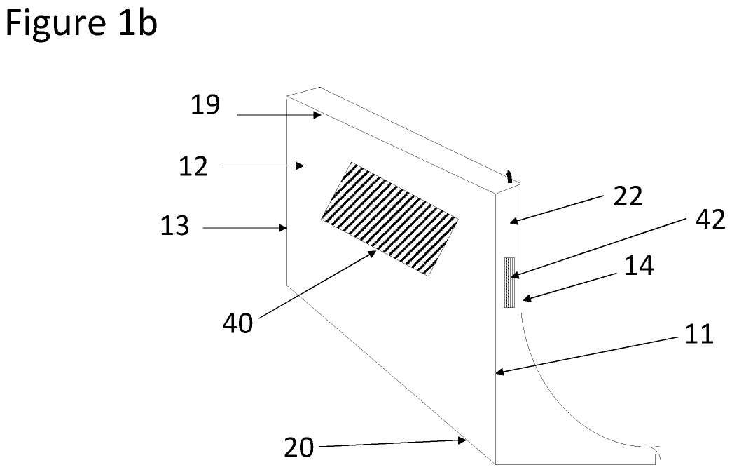

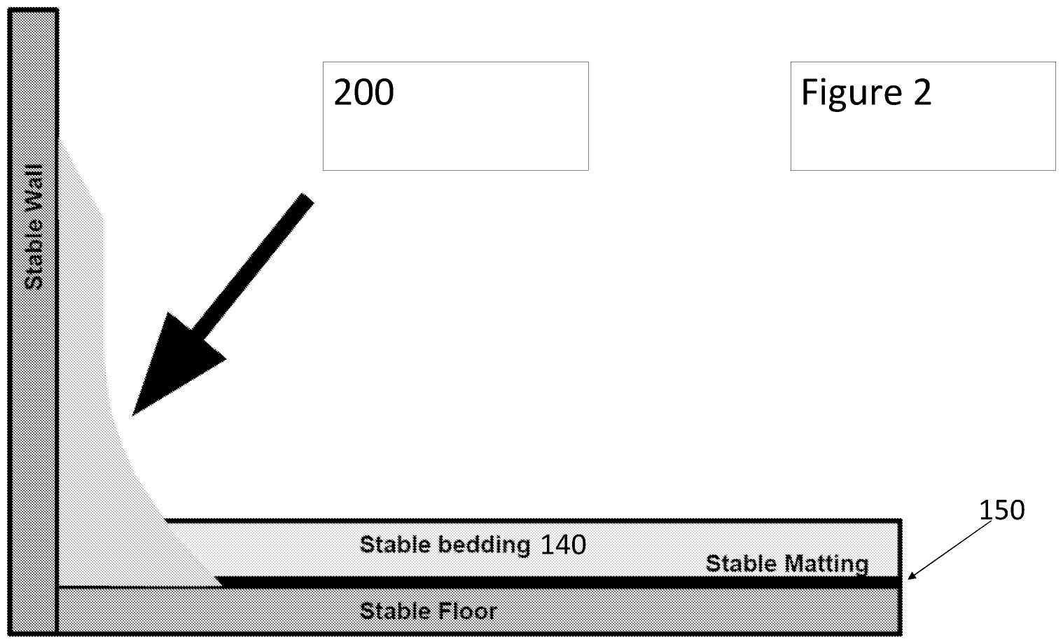

A preferred embodiment according to the invention is shown in perspective view in FIG. 1a. A reusable equine bank device 100 has a substantially ramp shaped configuration with first and second faces for simultaneously abutting the wall and floor of a stable or similar building respectively and an angled front face including a concave portion. In use, the first face extends substantially vertical and the second face extends substantially horizontal. In the current embodiment, the first face is exemplified as a rectangular planar back wall 12, defined by superior and inferior edges 19 and 20 respectively, and side edges 11 and 13. The second face exemplified as a rectangular planar base 16 adjoined to the back wall 12 extending substantially perpendicularly from the back wall 12, preferably by a length of 60 cm. It will be appreciated that the dimensions of the device may vary. In preferred embodiments, the height of the first face against the back wall is 120 cm. For example, the first and second faces (for abutting the back wall and floor respectively) may be square.

The bank 100 has a sloped or angled front face 14 adjoining the first and second faces. In use, the angled front face acts to roll a cast horse away from the stable wall abutted to the back wall 12 of the bank 100. In the current example, the front face 14 of the bank 100, has a concave profile, curving from a lower edge 23 of the base 16 to an upper edge (ridge) 24. The angle of the curve of the front face 14 is such that the bank 100 is deepest at the base 16 and becomes shallower as it tends towards the ridge 24. The curved front face 14 maximises the space of the stables allowing room for the flanks of the horse whilst maintain the angles surface beneficial for preventing the horse from casting.

The bank 100 is defined by planar side walls 22 adjoined to the back wall 12 and the base 16 at right angles. The confluence between the front face 14 and the side walls 22 forming curved edges 17 and 15 respectively. The sides (and optionally back wall) of the device are optionally provided with cutaways 42 enabling the device to be handheld.

In this example, the front face has a straight portion at the top next to the curved portion, adjacent to the wall at the top. This straight portion is beneficial because it provides a guard against sprayed horse urine, catching the sprayed urine and directing it towards the bedding where it can be absorbed.

In addition, the upper portions of the bank 100 provide a protective surface against horse urine. Mares in particular have a habit of spraying urine against the walls of their stalls. The urine can collect in cracks and corners of the stall, becoming toxic and supporting bacterial growth. In use, the curvature of the front wall 14 of the bank 10, catches the sprayed urine and directs it towards the bedding. The bedding will absorb the urine and prevent it from assisting bacterial growth.

In an embodiment, the bank 100 is solidly formed. In an alternative embodiment, the bank 10 is hollow, with an internal cavity (not shown). The walls surrounding the internal cavity are sufficiently thick to allow the bank 100 to support the weight of a horse or similar animal falling on it without breaking.

In this example, the device includes attachment means comprising magnetic elements 40, on the face abutting the stable wall, and on side faces of the device. For example, the magnets may fix to metallic or magnetic elements pre-fixed to the walls.

In use, the device 100 is situated, with the base 16 abutting the floor of a stables or similar building, proximal to a wall, such that the back wall 12 of the device 100 abuts the stable wall. The front face 14, in use, is oriented to face away from the wall and into the room and provides a sloped or curved surface which acts to roll a cast horse away from the abutted stable wall.

In preferred embodiments, the attachment means includes a magnetic element 40, as shown in FIGS. 1a and 1 b, for example on the face abutting the stable wall, and optionally on side faces of the device, for attachment to side walls of the stable (e.g. where the device is located in a corner of the stable). For example, the magnets may fix to metallic elements pre-fixed to the walls.

The secured banks resist movement during use, ensuring they are always ideally situated to prevent the horse from casting. Furthermore, by securing the banks proximal to the walls it helps to prevent horse urine, which is concentrated with ammonia, from coating the walls and corners of the stables where it can become a health issue. The sloped banking acts to funnel any sprayed urine down the bank towards the absorbent bedding materials. In a preferred embodiment, the attachment means includes a magnet which is easily attachable and detachable such that the user can remove the banks from their in-situ location for cleaning.

In preferred embodiments, the bank 100 is formed from a hard plastics material (e.g. by injection moulding) suitable for supporting the weight of a horse or similar animal. The term hard plastics is envisaged to include a range of synthetic or semisynthetic polymeric compounds with the desired properties that it is resistant to breaking under the weight of a horse. In an alternative embodiment, the bank is formed of a composite plastics material with a hard core or inner layer and a softer more tactile outer polymer layer. In a further preferred embodiment, the bank 10 is formed from or coated with a hydrophobic material which resists staining and makes it easier to clean. In an alternative embodiment, the bank is formed from wood, perspecs or metal. In a further alternative embodiment, the bank is formed of a composite material with a metal core or framework to provide structural strength and a polymeric plastics coating.

In an alternative embodiment, the bank incorporates an additive to the plastics material to provide antimicrobial properties. For example, silver additives or antimicrobial resins can be provided as an outer layer of the bank or incorporated into the mould. These antimicrobials act to kill or at least inhibit the growth of bacteria which thrive in the environments created by soiled bedding. These bacteria can be very harmful for the health of the stable animal.

In an embodiment, the bank 100 incorporates pigments in its outer surface to provide a desired colour, pattern, picture or wording.

In an embodiment, the banks 100 form a modular system whereby multiple banks 100 are arranged adjacent to one another around the walls of the stable. In an embodiment at least one of the side walls 20 and 22 incorporate a securing means suitable for securing adjacent banks 100 together. In a further embodiment, the securing means comprises a male and female attachments which engage to secure the banks together, such as a hook and bracket configuration. Alternatively, the banks 100 are secured by magnets (preferably), hooks, bolts, catches, straps or any other suitable means. In a preferred embodiment, the securing means is detachable such that the banks 100 can be removed for cleaning or transport and rearranged for changing needs. In an embodiment, the banks 100 have a sealing means around the periphery of at least one of side walls 22. In a further embodiment, the sealing means comprises a rubber ring. The sealing means prevents urine and other fluids from entering the gaps between banks 100 where it may promote bacterial growth.

In an embodiment (not shown), at least one of the side walls 20 and 22 project from the back wall at a 45-degree angle such that the width of the back wall is greater than that of the front face. This configuration is beneficial because it enables adjacent banks to abut in the corner of the stables, with a second bank at right angles to the first. In a further preferred embodiment, the abutting side walls which each project at 45 degrees from the respective back walls, incorporate securing means such as those exemplified in previous embodiments.

In an embodiment, the banks further comprise an integral stable matting, such that there is no seam between the banks and the matting for soiled material to leak through. This further reduces the damage caused by caustic urine and limits the moist environments favoured for bacterial growth.

FIG. 3 shows another embodiment of a reusable equine bank device 200 is cross sectional side view. The bank 200 has a similar configuration to the first embodiment, with a first and second faces which, in use, abut the wall and floor of a stable onto which stable matting 150 and stable bedding 140 is provided in use.

1. A reusable banking device suitable for use in buildings such as an equine stable, the device comprising first and second faces for respectively abutting a wall and the floor of the stable, and a front face extending therebetween, the front face comprising a curved, concave portion.

2. A reusable banking device according to claim 1, comprising at least one cavity.

3. A reusable banking device according to claim 1, wherein the height of the first face is 120 cm.

4. A reusable banking device according to claim 1, wherein the first face comprises an attachment means for securing the banking device against the wall wherein the attachment means includes a magnetic element.

5. A reusable banking device according to claim 1, formed of a hard-plastics material.

6. A reusable banking device according to claim 1, wherein the front face further comprises a straight portion for abutting a mat placed on the floor.

7. A reusable banking device according to claim 6, wherein the straight portion is 4 cm in height.

8. A reusable banking device according to claim 1, wherein the second face has a length of 60 cm.

9. A modular system comprising a reusable banking device according to claim 1.
